(19) United States
(12) Patent Application Publication
(10) Pub. No.: US 2015/0083887 A1
(43) Pub. Date: Mar. 26, 2015

(54) MODULAR SET-UP WINCH FOR A CRANE

(71) Applicant: Manitowoc Crane Group France SAS, Dardilly Cedex (FR)

(72) Inventor: Waldemar Mohr, Wilhelmshaven (DE)

(21) Appl. No.: 14/494,005

(22) Filed: Sep. 23, 2014

(30) Foreign Application Priority Data
Sep. 24, 2013 (DE) 202013008486.3

(51) Int. Cl. B66D 3/00; B66C 23/26; F16M 13/02

(52) U.S. Cl. CPC B66D 3/00; F16M 13/02; B66C 23/26
USPC 248/674; 254/323; 212/175

(57) ABSTRACT

A set-up winch for a crane, in particular for a mobile crane is designed as a transportable, modular unit. Characteristically, the winch's mounting element for mounting the winch to the crane comprises a securable quick-acting mounting system. Embodiments have a hang-in mounting system with a hang-in bolt and a safety bolt.

### RELATED APPLICATIONS

The present patent document claims the benefit of priority to German Patent Application No. 20 2013 008 486.3, filed Sep. 24, 2013, and entitled “MODULAR SET-UP WINCH FOR A CRANE,” the entire contents of each of which are incorporated herein by reference.

### BACKGROUND

This invention relates to a modular set-up winch and its technical environment, in particular its mounting element, and a crane equipped therewith.

Such set-up winches, also known as set-up and wind-in winches, are used to make the process of setting up a crane easier, in particular a mobile crane. By means of the winch, the main hoist rope can be pulled forwards for the different set-up states, for example.

A known approach is to integrate such set-up and wind-in winches on the rotary table of mobile cranes as fixed units constituting an integral part of the crane structure. Due to the fact that the components used for this purpose are highly integrated, winches of this type known from the prior art are not readily accessible for unlocking or control operations and their flexibility during use is low.

### BRIEF SUMMARY

The objective of this invention is to propose a set-up winch, in particular for a mobile crane, which at least partially overcomes the above-mentioned disadvantages of the prior art. In particular, the intention is to optimize overall functionality.

This objective is achieved on the basis of a set-up winch as defined in claim 1, by means of a mounting element for such a set-up winch as defined in claim 8, as well as a crane as defined in claim 12. The dependent claims define preferred embodiments of the invention.

A set-up winch as proposed by the invention is suitable in particular for a mobile crane and is designed as a transportable, modular unit, and the winch's mounting element for mounting on the crane comprises a securable quick-acting mounting system. At this stage, it should be noted that the expression “modular unit” should be understood as meaning that the set-up winch is designed as a single, distinct module so that it can be transported as a complete unit. Naturally, this does not rule out the fact that the winch itself may comprise individual units which can be assembled in a modular fashion—details of specific embodiments in this connection will be given later.

In other words, the set-up winch proposed by the invention is therefore designed as an intrinsically closed system and can be fitted and dismantled as a whole and secured to the crane at an appropriate point with the aid of the winch's securable quick-acting mounting system (i.e. on the winch) without the need for any complex technical features. The very fact that it can be secured to the crane at different or various points in principle significantly increases the flexibility of such winches proposed by the invention during use. Furthermore, they can be secured to readily accessible points, thereby reducing fitting and set-up times. A major advantage of the set-up winch proposed by the invention resides in the fact that it can be made available and sold as a piece of auxiliary equipment and all possible cranes and mobile cranes can be equipped with this winch by means of simple modifications. Controllability is improved because this factor can be easily taken into account when choosing where it will be mounted.

Based on one embodiment, the set-up winch is designed as a functionally closed module from the outside incorporating all the essential components of a winch. This design makes it particularly flexible and very easy to use, even with different types of crane.

Based on one embodiment, the crane winch is designed as a module with a rope winch mounted in a steel frame and a mounting element for the winch disposed on the steel frame. As already mentioned above, the winch may be regarded as a separate module but in the case of this embodiment it incorporates a few modular-type components and units in addition, which in turn facilitates assembly of the set-up winch, its maintenance and its operation. This aspect means that virtually only the power supply needs to be provided on the crane in addition to the mounting element. Accordingly, the winch, even in its very general form described above, is a stand-alone, independently operable unit.

Based on another variant, the set-up winch has a one-sided mounting element or a mounting element disposed on only one of its sides. Firstly, this means that a mounting element can be provided in the form of a hang-in system with a lock to prevent it from slipping out, and secondly, again in a more detailed design, the mounting element may comprise a clevis hook or hang-in bolt. A hang-in system specifically makes for very rapid mounting and bolt locks can be provided in any size and in all situations, requiring little space, as a result of which this special embodiment highlights the advantages of the set-up winch proposed by the invention particularly well. As already mentioned above, the securable, quick-acting mounting system may have a safety bolt.

Based on another aspect, this invention further relates to a mounting element for a set-up winch based on various designs, as will be described, and the mounting element has a mounting element for the crane in order to mount the set-up winch, which comprises a mounting system complementing the quick-acting mounting system of the set-up winch. This being the case, the mounting element may be designed so that it is suitable for a one-sided mounting of the set-up winch, in particular as a one-sided cantilever. A support with a clevis hook or bolt hang-in holder may be provided and in the case of another embodiment, the crane's mounting element is a support with a holding means for a safety bolt.

In other words, the mounting element constitutes the complementary piece to the winch's mounting element and has another quick-acting mounting system which co-operates with the quick-acting mounting system of the set-up winch. The advantages of the different designs described above were explained earlier on and naturally also apply to the mounting element proposed by the invention.

Based on another aspect of the invention, a crane is disclosed which has a set-up winch of the type described above and based on any of the various embodiments described here, and/or a mounting element, as also described above and based on the various embodiments described here.

There are various points on the crane where the crane's mounting element proposed by the invention may be disposed, thereby offering specific advantages. If, as is possible on the basis of this invention, the crane is provided with several mounting elements, the position in which it is used may be selected depending on the set-up state required. However, even if only a single position is provided, the set-up winch system offers the advantages which come with a modular design as already described above. These advantages include, for example, the possibility of providing the set-up winch as a piece of auxiliary equipment for different cranes as well as the advantage relating to maintenance and control.

One option with regard to position is to secure the crane's mounting element on or to a counterweight element, which in particular makes for free accessibility and, consequently, easier controllability and also offers a simple way of making various appropriate set-up positions available.

Another positioning option is the auxiliary hoist fixing mechanism, and in the case of many cranes, this is precisely where the crane driver can work safely when controlling the set-up winch because such usage positions can usually be reached by means of fixed steps. At both of the above-mentioned positions, an anti-slip standing surface is often provided, as well as supporting devices such as handrails. This ready accessibility enables the reeling behavior of the winch to be controlled and corrected and because the practical positioning means that space is available in the surrounding area, the set-up winch (hand set) can be controlled from a position directly adjacent to the winch, which affords a very good overall view of the work in hand.

### BRIEF DESCRIPTION OF THE DRAWINGS

The invention will be described in more detail below on the basis of various embodiments and with reference to the appended drawings. Of these:

FIG. 1 illustrates the mounting of a set-up winch as proposed by the invention on the rear rotary table, using the auxiliary hoist fixing mechanism of a mobile crane;

FIG. 2 illustrates the mounting of a set-up winch proposed by the invention on a counterweight element of a mobile crane;

FIG. 3 is a view seen from an angle showing the modular set-up winch based on one embodiment proposed by the invention; and

FIG. 4 shows the set-up winch illustrated in FIG. 3 suspended on a mounting element of the crane.

### DETAILED DESCRIPTION

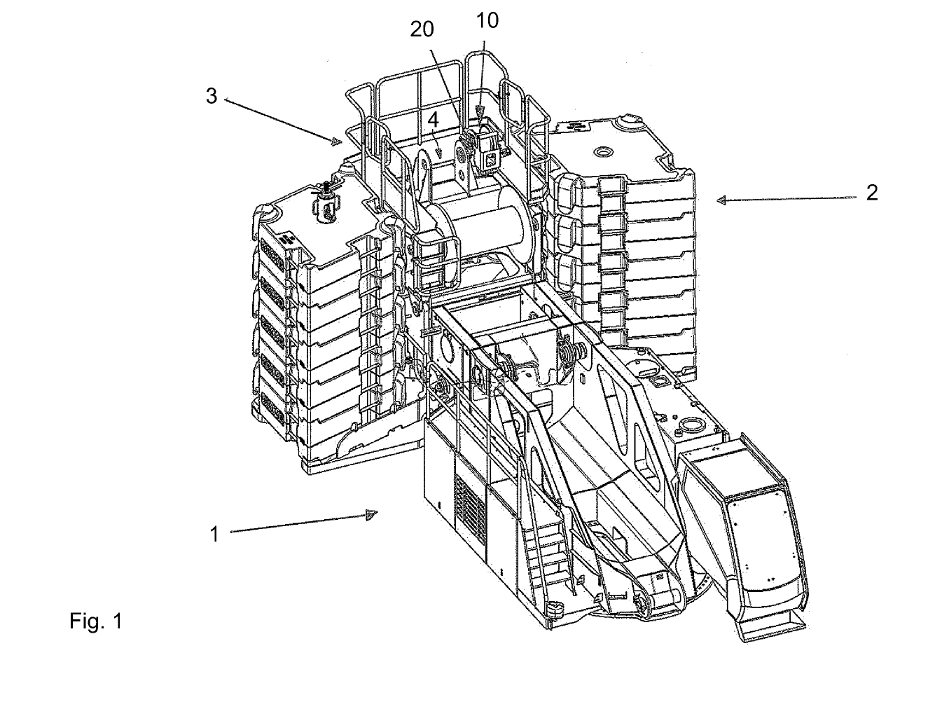

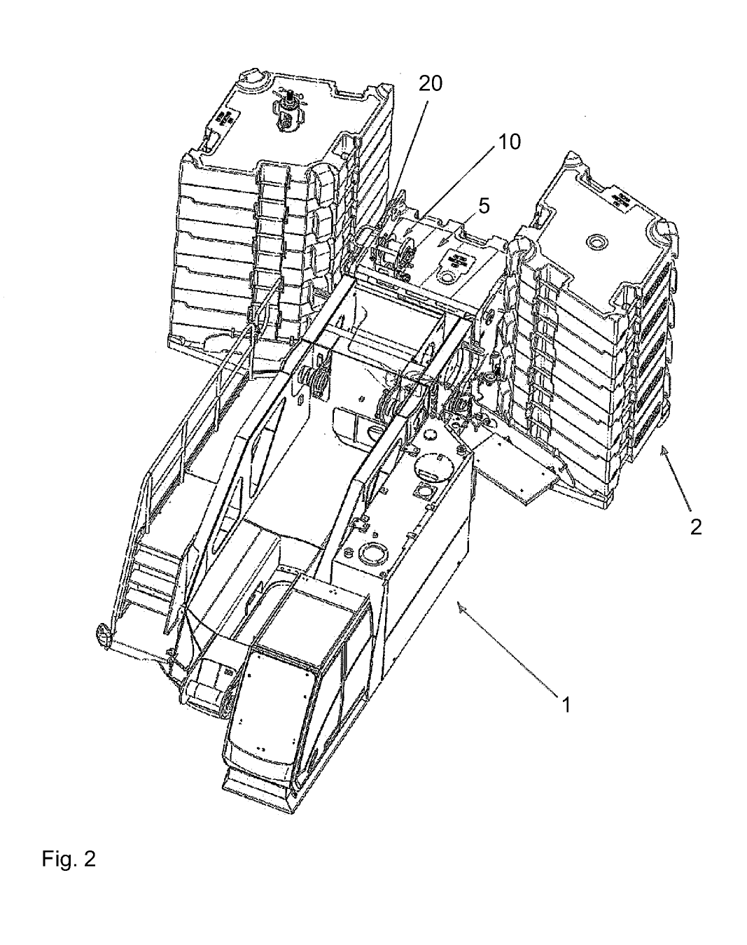

This description will refer firstly to FIGS. 1 and 2 to explain different usage or positioning options for a set-up winch as proposed by the invention. In FIGS. 1 and 2, reference number 1 denotes as a whole a part of the top cab of a mobile crane and the counterweight elements are denoted by reference number 2. Reference number 10 in these two drawings denotes a set-up winch or a set-up and wind-in winch, whilst reference number 20 denotes a mounting element on the crane for this winch 10.

As may be seen from FIG. 1, an auxiliary hoist fixing mechanism 4 with two outer support stands is provided on the rear upper rotary table area 3, which is used to mount the auxiliary hoist, although this is not illustrated. The right-hand one of the two supports in this embodiment is additionally used to secure the set-up winch by its external side. The advantage of this positioning can be seen particularly clearly because firstly, fixed steps and handrails are provided in the region of the set-up winch 10 and secondly, control operations can take place in the immediate vicinity.

As may be seen from the embodiment illustrated in FIG. 2, the crane's mounting element 20 is disposed on a counterweight element 5 where it supports the set-up winch 10. This also offers ready accessibility and because several appropriate options for the fixing mechanism are available on the counterweight, i.e. at several points, the winch can be mounted very easily in a particularly advantageous position for whatever work has to be carried out.

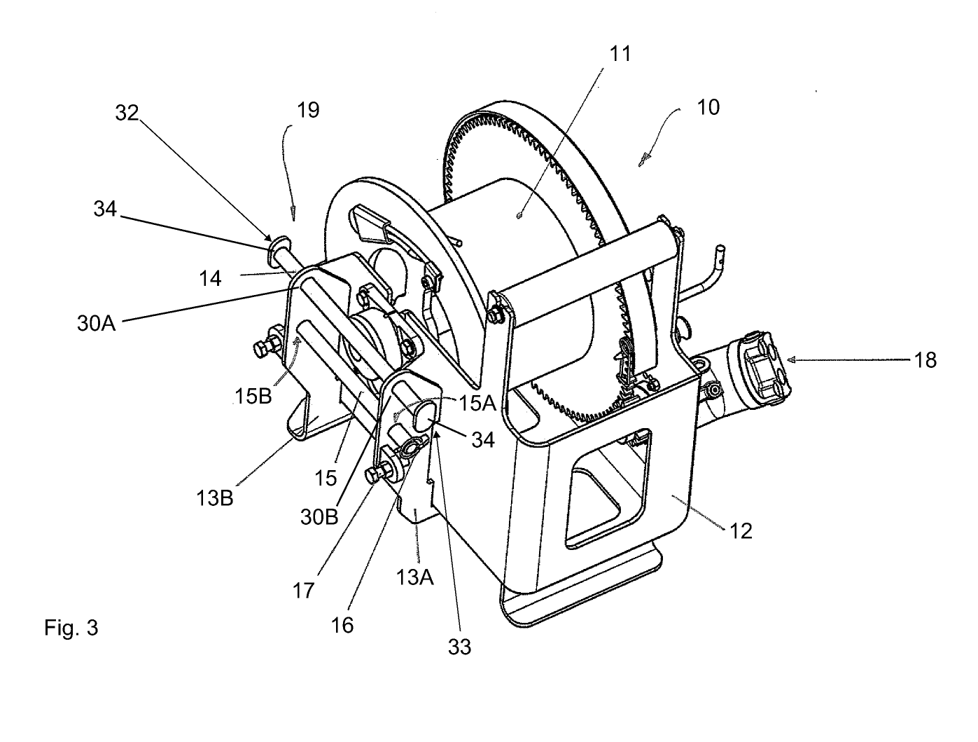

FIG. 3 illustrates what one possible embodiment of a set-up winch module 10 looks like. There are four main units, namely the rope winch 11 with its mechanical components, the steel frame 12 for mounting the rope winch 11 and the other add-on parts, the power socket 18 and the winch's quick-acting mounting system or mounting element which is denoted as a whole by reference number 19. The mounting element 19 together with the steel frame 12 constitutes a self-supporting frame, thereby enabling additional retaining means to be dispensed with and offering corresponding savings on costs and weight.

The mounting element 19 has two supporting plates 13A and 13B extending vertically up from the frame 12, on which the other elements of the quick-acting mounting system are mounted. These comprise a hang-in bolt 14, or a clevis hook in some embodiments, mounted in two aligned end-to-end bores 30A and 30B. The hang-in bolt 14 is provided at its two ends 32, 33 with plates 34 so that it is not able to slip out of its end-to-end or guide bores 30A and 30B. Disposed further down, likewise in a guide comprising two aligned bores 15A and 15B in supports 13A and 13B, is the safety bolt 15 which, although designed so that it can be removed, may be provided with a locking mechanism 16 at its end, in this instance provided in the form of a lynchpin. Also disposed underneath the end-to-end bores 15A, 15B for the safety bolt 15 are two adjustable spacers 17.

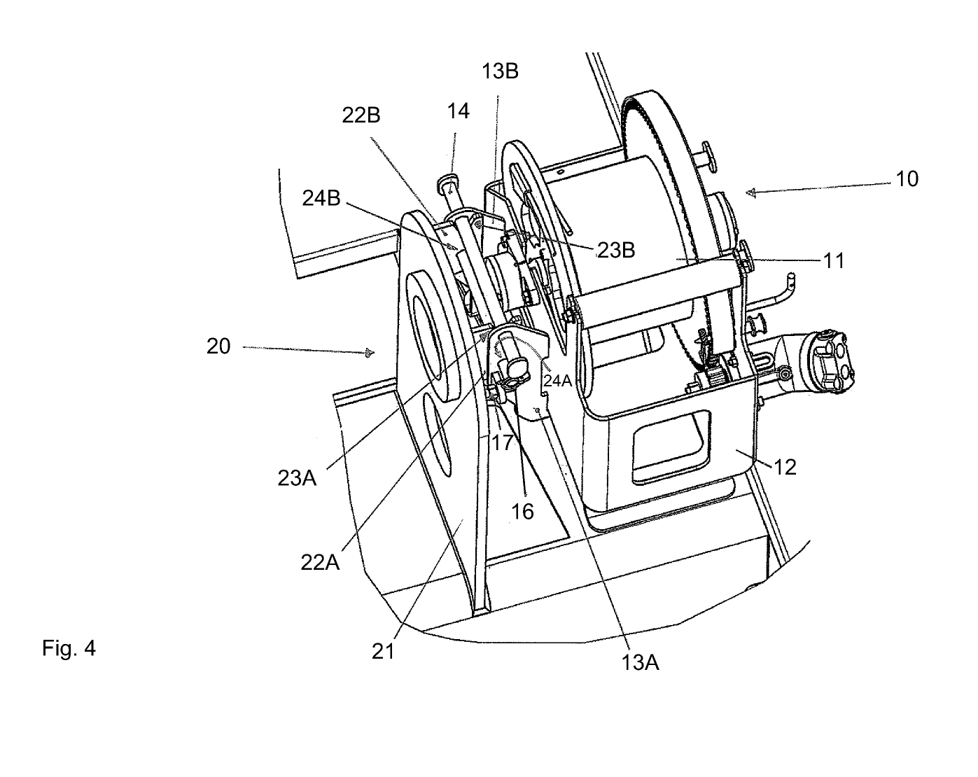

This set-up winch module can now be rapidly, easily and safely mounted in a co-operating mounting element 20, the mounted state being illustrated in FIG. 4. The mounting element 20 illustrated in FIG. 4 is the same as the one illustrated in the general view of FIG. 1 and the reference numbers denoting the set-up winch in FIG. 4 correspond to those given in FIG. 3 and relate to the same parts.

The main part of the mounting element 20 is the upright support 21, which in turn has two supporting plates 22A and 22B at its top right-hand side. At their top edge, the two supporting plates 22A, 22B have aligned holding structures for hang-in bolts 14 provided in the form of round recesses denoted by reference numbers 23A and 23B in FIG. 4. In order to hang the set-up winch 10 in, with the safety bolt 15 still removed, the hang-in bolt 14 is placed in the hang-in holders 23A and 23B from above so that the two supports 13A and 13B of the winch 10 extend around the crane's supporting plates 22AA and 22B, respectively, from outside. The spacers 17 (FIG. 3) can then be used to correct the tilt position of the set-up winch-module 10 if necessary—in most situations, however, the spacers 17 are already set so that the tilt position is one in which the end-to-end bores 15A, 15B (FIGS. 3) and 24A, 24B in the supports 13A, 13B, 22A, 22B are aligned and the safety bolt 15 with the locking mechanism, or end lock 16 removed can be pushed through both the end-to-end bores 15A, 15B of the supporting plates 13A, 13B of the winch 10 and the end-to-end bores 24A, 24B of the supporting plates 22A, 22B of the mounting element 20, respectively, after which the end lock 16 is fitted to prevent the safety bolt from slipping out.

The set-up winch is therefore secured on the crane by a rapid, easy and safe quick-acting mounting system and can now be used for its work.

1. A set-up winch for a mobile crane, comprising a winch that is a transportable, modular unit, and a mounting element for mounting the winch on the crane comprising a securable quick-acting mounting system.

2. The set-up winch as claimed in claim 1, wherein the winch is configured as a functionally closed module that incorporates all the functionally essential components of a winch.

3. The set-up winch as claimed in claim 1, wherein the winch comprises a module with a rope winch mounted in a steel frame and the mounting element is disposed on the steel frame.

4. The set-up winch as claimed in claim 1, wherein the mounting element is disposed on only one side of the winch.

5. The set-up winch as claimed in claim 1, wherein the mounting element further comprises a hang-in system with a locking mechanism.

6. The set-up winch as claimed in claim 1, wherein the mounting element comprises one of a clevis hook and a hang-in bolt.

7. The set-up winch as claimed in claim 1, further comprising a safety bolt.

8. The set-up winch as claimed in claim 1, further comprising another mounting element on the crane for mounting the winch, the another mounting element comprising a mounting system that complements the quick-acting mounting system.

9. The set-up winch as claimed in claim 8, wherein the another mounting element is configured to permit a one-sided mounting in the form of a one-sided cantilever of the winch.

10. The set-up which as claimed in claim 8, wherein the another mounting element has a support with one of a clevis hook and a hang-in holder for a hang-in bolt.

11. The set-up winch as claimed in claim 8, wherein the another mounting element has a support with an end-to-end bore for a safety bolt.

12. A mobile crane, comprising a set-up configured as a transportable, modular unit, and a mounting element for mounting the set-up winch on the crane comprising a securable quick-acting mounting system.

13. The mobile crane as claimed in claim 12, further comprising at least another mounting element on the crane for mounting the winch, the another mounting element comprising a mounting system that complements the quick-acting mounting system.

14. The mobile crane as claimed in claim 13, wherein the another mounting element is disposed on an auxiliary hoist fixing mechanism.

15. The mobile crane as claimed in claim 13, wherein the another mounting element is configured to be at least one of secured to a counterweight element and secured on the counterweight element.

16. The mobile crane as claimed in claim 13, further comprising a plurality of another mounting elements, wherein each of the plurality of another mounting elements is configured to be at least one of secured on an auxiliary hoist fixing mechanism, securing to a counterweight element, and secured on the counterweight element.

17. A mounting system for a set-up winch on a crane, comprising:
a mounting element coupled to the set-up winch, the mounting element including:
a first mounting plate and a second mounting plate spaced apart from the first mounting plate, each mounting plate including a guide bore;
a hang-in bolt configured to extend through each guide bore of the first mounting plate and the second mounting plate;
another mounting element coupled to the crane, the another mounting element including:
an upright support;
a first supporting plate and a second supporting plate spaced apart from the first supporting plate, each of the first supporting plate and the second supporting plate being coupled to the upright support, each supporting plate including a hang-in holder configured to receive the hang-in bolt.

18. The mounting system of claim 17, wherein the first mounting plate and the second mounting plate each further include an end-to-end bore, and wherein the first supporting plate and the second supporting plate each further include another end-to-end bore, and wherein the mounting system further comprises a safety bolt configured to extend through each end-to-end bore of the first mounting plate and the second mounting plate and through each another end-to-end bore of the first supporting plate and the second supporting plate.

19. The mounting system of claim 18, further comprising a locking mechanism configured to lock the safety bolt within each of the end-to-end bores and the another end-to-end bores.

20. The mounting system of claim 18, further comprising at least one spacer configured to align each of the end-to-end bores with each of the another end-to-end bores.
